(19) United States
(12) Patent Application Publication
(10) Pub. No.: US 2025/0245473 A1
(43) Pub. Date: Jul. 31, 2025

(54) METHOD FOR GENERATING MULTI-AGENT ADVERSARIAL POLICY BASED ON HETEROGENEOUS RELATIONSHIP AND RELATED APPARATUS

(71) Applicant: Shanghai University, Baoshan District (CN)

(72) Inventors: Shaorong XIE, Baoshan District (CN); Xiangfeng LUO, Baoshan District (CN); Xinzhi WANG, Baoshan District (CN); Yang LI, Baoshan District (CN); Zhenyu ZHANG, Baoshan District (CN)

(21) Appl. No.: 19/023,585

(22) Filed: Jan. 16, 2025

(30) Foreign Application Priority Data
Jan. 25, 2024 (CN) 202410109038.6

(51) Int. Cl. G06N 3/004

(52) U.S. Cl. CPC G06N 3/004

(57) ABSTRACT

Provided are a method for generating a multi-agent adversarial policy based on a heterogeneous relationship and a related apparatus. The method includes: constructing, based on a heterogeneous relationship between agents and a spatial topology structure of each agent, a situation relationship diagram of each agent. A local situation information fusion vector of the agent is determined based on the situation relationship diagram of the agent. Finally, a proper adversarial policy is made, based on the local situation information fusion vector of the agent by utilizing a pre-trained adversarial policy generation model of the agent. On the basis of the spatial topology structure, the heterogeneous relationship between agents is taken into consideration to generate the situation relationship diagram, so that the adversarial strategy generation model can have a better understanding of a situation relationship between agents, and adapt to a gaming situation dynamic change condition between agents.

### CROSS REFERENCE TO RELATED APPLICATION

This patent application claims the benefit and priority of Chinese Patent Application No. 2024101090386, filed with the China National Intellectual Property Administration on Jan. 25, 2024, the disclosure of which is incorporated by reference herein in its entirety as part of the present application.

### TECHNICAL FIELD

The present disclosure relates to the field of multi-agent adversarial gaming, and in particular, to a method for generating a multi-agent adversarial policy based on a heterogeneous relationship and a related apparatus.

### BACKGROUND

An adversarial policy learning algorithm has an important theoretical research and application value in the field of multi-agent reinforcement learning. A plurality of agents in a game usually need to collaborate to achieve a common goal and protect individual interests in competition. Inter-game adversarial policy learning can help the agents find a balance between cooperation and competition and adapt to a dynamic change of a game environment through real-time adjustment of an adversarial policy, so as to maintain efficiency and stability of a system and improve overall performance of the system. Related theoretical methods and technical means can be applied to a plurality of fields such as network security, smart finance, intelligent transportation, and military strategies.

However, there is heterogeneity between agents of a game and different agents may have different goals and policies. This heterogeneous relationship makes a game situation more diversified and complex. In this case, the agents need to consider various heterogeneity factors at the same time, and consequently, difficulty in understanding a game environment is increased. In addition, as the game environment usually changes dynamically, the behavior and status of each agent may evolve continuously to continuously adapt to the change, and therefore, stability and predictability of the game situation are reduced.

The current research method focuses on the expression of a multi-agent spatial topology structure to help understand and analyze interaction between game agents. However, if the conventional spatial topology structure uses a fixed neighborhood, a game situation between an agent and an agent in a neighborhood of the agent can only be expressed. This may be excessively simplified in some cases and cannot capture an important relationship of a global situation. In addition, modeling and understanding of the global situation are limited as only a relationship of the agents in a local neighbor is considered.

In conclusion, in the current multi-agent game confrontation technology, a type of heterogeneous relationship between agents of a game is ignored. This results in an inaccurate expression of an entire game situation during actual application.

### SUMMARY

An objective of the present disclosure is to provide a method for generating a multi-agent adversarial policy based on a heterogeneous relationship and a related apparatus, to improve understanding of a generation model on a gaming situation, and ensure effectiveness of a generated adversarial policy.

To achieve the above objective, the present disclosure provides the following technical solutions.

According to one aspect, the present disclosure provides a method for generating a multi-agent adversarial policy based on a heterogeneous relationship, including the following steps:
constructing for any agent, based on a heterogeneous relationship between the agent and another agent and a spatial topology structure of each agent, a situation relationship diagram of the agent, where the heterogeneous relationship includes a cooperative relationship and a competitive relationship; the situation relationship diagram includes a situation relationship adjacency matrix and a situation relationship feature matrix; the situation relationship adjacency matrix represents the heterogeneous relationship between the agent and another agent; and the situation relationship feature matrix represents locally-observed information of each agent;
determining, based on the situation relationship diagram of the agent, a local situation information fusion vector of the agent, where the local situation information fusion vector is obtained according to locally-observed information of a closest cooperative agent of the agent and locally-observed information of a closest competitive agent of the agent; the closest cooperative agent is an agent whose heterogeneous relationship with the agent is the cooperative relationship and spatial distance to the agent is the shortest; and the closest competitive agent is an agent whose heterogeneous relationship with the agent is the competitive relationship and spatial distance to the agent is the shortest; and
inputting the local situation information fusion vector of the agent into an adversarial policy generation model of the agent to obtain an adversarial policy of the agent, where the adversarial policy generation model is a model obtained after centralized training is performed on an initial adversarial policy generation model for all agents and an initial coalition policy estimation model for all agents; the coalition policy estimation model is configured to score a coalesced adversarial policy vector according to a global situation information fusion vector of the agent; and the coalesced adversarial policy vector is a vector obtained by coalescing adversarial policies made by the adversarial policy generation model for all agents.

Optionally, a training process of the adversarial policy generation model of the agent includes:
initializing a model parameter of the adversarial policy generation model of the agent and a model parameter of the coalition policy estimation model of the agent to obtain an initial adversarial policy generation model of the agent and an initial coalition policy estimation model of the agent;
taking the initial adversarial policy generation model of the agent as a current adversarial policy generation model, and taking the initial coalition policy estimation model of the agent as a current coalition policy estimation model;
calculating, according to the current adversarial policy generation model and the current coalition policy estimation model, a loss function value of the coalition policy estimation model and a gradient value of the adversarial policy generation model;
updating, according to the loss function value of the coalition policy estimation model, the model parameter of the coalition policy estimation model by using a gradient descent algorithm to obtain an intermediate coalition policy estimation model;
updating, according to the gradient value of the adversarial policy generation model, the model parameter of the adversarial policy generation model by using a gradient ascent algorithm to obtain an intermediate adversarial policy generation model;
determining whether a preset training end condition is met, to obtain a training end determining result; and
if the training end determining result is yes, taking the intermediate adversarial policy generation model as the adversarial policy generation model of the agent, and taking the intermediate coalition policy estimation model as the coalition policy estimation model of the agent; or
if the training end determining result is no, taking the intermediate adversarial policy generation model as the current adversarial policy generation model, taking the intermediate coalition policy estimation model as the current coalition policy estimation model, and skipping to the following step: calculating, according to the current adversarial policy generation model and the current coalition policy estimation model, the loss function value of the coalition policy estimation model and the gradient value of the adversarial policy generation model until the preset training end condition is met.

Optionally, the constructing for any agent, based on a heterogeneous relationship between the agent and another agent and a spatial topology structure of each agent, a situation relationship diagram of the agent specifically includes:
initializing the situation relationship diagram of the agent to obtain an initial situation relationship diagram of the agent; and
updating, according to the heterogeneous relationship between the agent and another agent and locally-observed information of all agents, the initial situation relationship diagram of the agent, to obtain the situation relationship diagram of the agent.

Optionally, the situation relationship diagram includes the situation relationship adjacency matrix and the situation relationship feature matrix, and the initializing the situation relationship diagram of the agent specifically includes:
setting data in the situation relationship adjacency matrix to zero, and setting data in the situation relationship feature matrix to zero, to obtain the initial situation relationship diagram of the agent.

According to another aspect, the present disclosure provides a computer device, including a memory, a processor, and a computer program stored in the memory and executable on the processor, where the processor executes the computer program to implement steps of the method for generating a multi-agent adversarial policy based on a heterogeneous relationship.

According to specific embodiments provided in the present disclosure, the present disclosure has the following technical effects:

The present disclosure provides a method for generating a multi-agent adversarial policy based on a heterogeneous relationship and a related apparatus. The method includes the following steps: constructing, based on a heterogeneous relationship between agents and a spatial topology structure of each agent, a situation relationship diagram of each agent; determining, based on the situation relationship diagram of the agent, a local situation information fusion vector of the agent; and finally, making, based on the local situation information fusion vector of the agent, a proper adversarial policy by utilizing a pre-trained adversarial policy generation model of the agent. On the basis of the spatial topology structure, the heterogeneous relationship between agents is taken into consideration to generate the situation relationship diagram, so that a decision-making and generation model can have a better understanding of the situation relationship between agents. Compared with a solution of understanding a situation by only using spatial topology, the solution in the present disclosure can adapt to a gaming situation dynamic change condition between agents, express a gaming situation more accurately, improves an understanding and adapting capability of the generation model to the gaming situation, guides the agent to generate an effective adversarial policy for the adversarial policy generation model, and helps the agent achieve gaming adversarial balance.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a flowchart of a method for generating a multi-agent adversarial policy based on a heterogeneous relationship according to Embodiment 1 of the present disclosure;

FIG. 2 is a specific flowchart of step A1 in a method for generating a multi-agent adversarial policy based on a heterogeneous relationship according to Embodiment 1 of the present disclosure;

FIG. 3 is a schematic diagram of a situation relationship diagram in a method for generating a multi-agent adversarial policy based on a heterogeneous relationship according to Embodiment 1 of the present disclosure;

FIG. 4 is a specific flowchart of a training process of an adversarial policy generation model in a method for generating a multi-agent adversarial policy based on a heterogeneous relationship according to Embodiment 1 of the present disclosure; and

FIG. 5 is a diagram of an internal structure of a computer device according to Embodiment 2 of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

An objective of the present disclosure is to provide a method for generating a multi-agent adversarial policy based on a heterogeneous relationship and a related apparatus, to improve understanding of a generation model on a gaming situation, and ensure effectiveness of a generated adversarial policy.

In order to make the above objective, features and advantages of the present disclosure clearer and more comprehensible, the present disclosure will be further described in detail below in combination with accompanying drawings and particular implementation modes.

### Embodiment 1

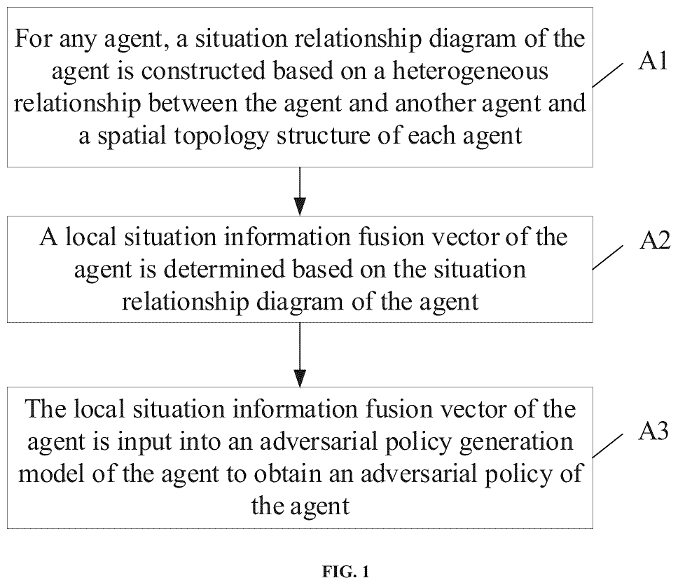

As show in a flowchart in FIG. 1, a method for generating a multi-agent adversarial policy based on a heterogeneous relationship is disclosed in this embodiment, including the following steps.

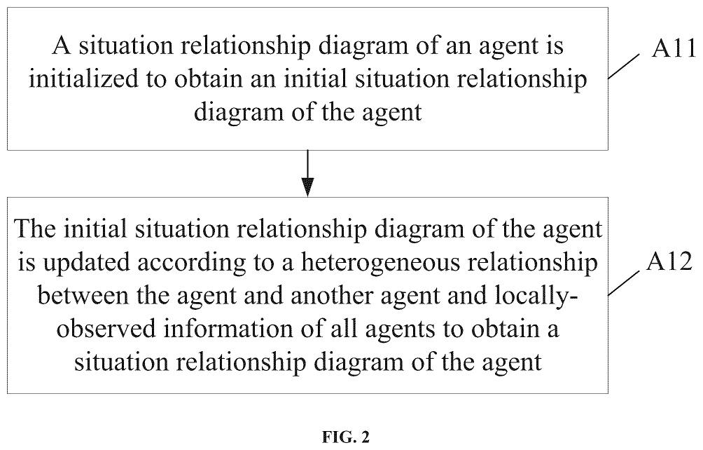

Step A1, for any agent, a situation relationship diagram of the agent is constructed based on a heterogeneous relationship between the agent and another agent and a spatial topology structure of each agent. The heterogeneous relationship includes a cooperative relationship and a competitive relationship. The situation relationship diagram includes a situation relationship adjacency matrix and a situation relationship feature matrix. The situation relationship adjacency matrix represents the heterogeneous relationship between the agent and another agent. The situation relationship feature matrix represents locally-observed information of each agent. In this embodiment, as shown in the flowchart in FIG. 2, the step A1 specifically includes following steps.

Step A11, the situation relationship diagram of the agent is initialized to obtain an initial situation relationship diagram of the agent. Specifically, data in the situation relationship adjacency matrix is set to zero, and data in the situation relationship feature matrix is set to zero, to obtain the initial situation relationship diagram of the agent.

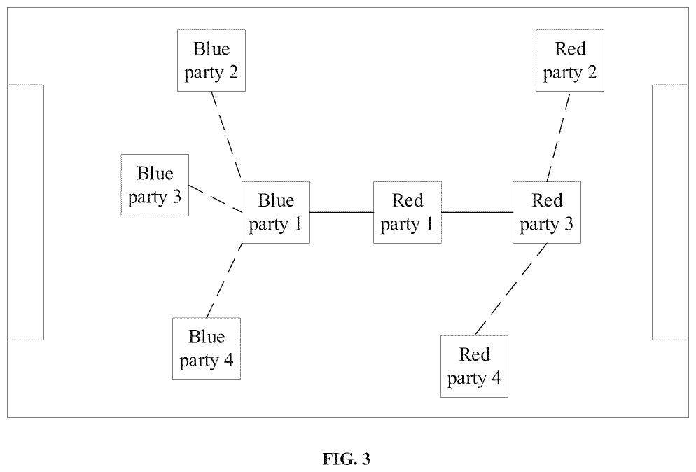

Step A12, the initial situation relationship diagram of the agent is updated according to the heterogeneous relationship between the agent and another agent and locally-observed information of all agents to obtain the situation relationship diagram of the agent. An expression manner is changed, and an expression formula of the situation relationship diagram of the agent is as follows:

$${G}_{i} = 〈 {A}_{i} , {X}_{i} 〉 ,$$

where
i represents a reference number of an agent, Gᵢ represents a situation relationship diagram of agent i, Aᵢ represents a situation relationship adjacency matrix under a perspective of the agent i and indicates a heterogeneous relationship between the agent and another agent, Xᵢ represents a situation relationship feature matrix under the perspective of the agent i and indicates locally-observed information of each agent. As shown in the schematic diagram of the situation relationship diagram shown in FIG. 3, a plurality of agents are included: four red-party robots and four blue-party robots.

Step A2, a local situation information fusion vector of the agent is determined based on the situation relationship diagram of the agent. The local situation information fusion vector is obtained according to locally-observed information of a closest cooperative agent of the agent and locally-observed information of a closest competitive agent of the agent. The closest cooperative agent is an agent whose heterogeneous relationship with the agent is the cooperative relationship and spatial distance to the agent is the shortest. The closest competitive agent is an agent whose heterogeneous relationship with the agent is the competitive relationship and spatial distance to the agent is the shortest. As shown in the situation relationship diagram in FIG. 3, for a red-party 1 robot, a blue party 1 and a red party 3 are two agents with a shortest spatial distance, and heterogeneous relationships of the blue party 1 and the red part 3 with the red party 1 are respectively a competitive relationship and a cooperative relationship. In this case, the corresponding blue party 1 is a closest competitive agent of the red party 1, and the red party 3 is a closest cooperative agent of the red party 1.

In this embodiment, the local situation information fusion vector of the agent may be determined according to the following formula:

$${e}_{i}^{π} = {Σ}_{j ∈ {𝒞}_{i}^{Local}} {α}_{i j} {e}_{i j} ,$$

where
eᵢ^{π} is a local situation information fusion vector of the agent i, j is a reference number of an agent, [symbol] ᵢ^{Local} is a closest agent set of the agent i, the closest agent set includes a closest cooperative agent of the agent and a closest competitive agent of the agent, eᵢⱼ is a concatenation vector of the agent i and agent j, and αᵢⱼ is a fusion weight of the concatenation vector of the agent i and the agent j.

The concatenation vector eᵢⱼ of the agent i and the agent j is calculated according to the following formula:

$${e}_{i j} = {f}^{concatenate} ( {e}_{i} , {e}_{j} ) ,$$

where
ƒ^{concatenate}(,⋅) is a vector concatenation function, eᵢ is a feature encoding vector of the agent i, and eⱼ is a feature encoding vector of the agent j.

The feature encoding vector eᵢ of the agent i is calculated according to the following formula:

$${e}_{i} = {f}^{e n c o d i n g} ( {o}_{i} ; {W}_{i , E} ) ,$$

where

ƒ^{encoding}(⋅;W_{i,E}) is a feature encoding model of the agent i, W_{i,E} is a model parameter of the feature encoding model of the agent i, and oᵢ is locally-observed information of the agent i.

The feature encoding vector eⱼ of the agent j is calculated according to the following formula:

$${e}_{j} = {f}^{e n c o d i n g} ( {o}_{j} ; {W}_{i , E} )$$

where
oⱼ is locally-observed information of the agent j.

The fusion weight αᵢⱼ of the concatenation vector of the agent i and the agent j is calculated according to the following formula:

$${α}_{i j} = {f}^{softmax} ( {e}_{i j} ) = \frac{exp ( {e}_{i j} )}{{Σ}_{l ∈ {𝒞}_{i}^{Local}} exp ( {e}_{i l} )} ,$$

where
ƒ^{softmax}(⋅) is a fusion weight calculation function, exp(⋅) is an exponential function with a natural constant e as a base, l is a reference number of an agent, and eᵢₗ is a concatenation vector of the agent i and the agent l.

Step A3, the local situation information fusion vector of the agent is input into an adversarial policy generation model of the agent to obtain an adversarial policy of the agent. In this embodiment, an expression formula of the adversarial policy generation model of the agent is shown as the following formula:

$${a}_{i} = {f}^{π} ( {e}_{i}^{π} ; {W}_{i , π} ) ,$$

where
aᵢ is an adversarial policy of the agent i, ƒ_{π}(⋅;W_{i,π}) is an adversarial policy generation model of the agent i, eᵢ^{π} is a local situation information fusion vector of the agent i, and W_{i,π} is a model parameter of the adversarial policy generation model of the agent i.

Specifically, the adversarial policy generation model applied in step A3 is a model obtained after centralized training is performed on an initial adversarial policy generation model for all agents and an initial coalition policy estimation model for all agents. The coalition policy estimation model is configured to score a coalesced adversarial policy vector according to a global situation information fusion vector of the agent. The coalesced adversarial policy vector is a vector obtained by coalescing adversarial policies made by the adversarial policy generation model for all agents. In this embodiment, an expression formula of coalition policy estimation model of the agent is shown as the following formula:

$${Q}_{i} ( {e}_{i}^{Q} , a ) = {f}^{Q} ( {e}_{i}^{Q} , a ; {W}_{i , Q} ) ,$$

where
[symbol] (eᵢ^{Q},a) is a score given by a coalition policy estimation model of the agent i for a according to eᵢ^{Q}, [symbol] is the coalition policy estimation model of the agent i, [symbol] is a model parameter of the coalition policy estimation model of the agent i, a is the coalesced adversarial policy vector obtained by coalescing adversarial policies made by the adversarial policy generation model for all agents, and eᵢ^{Q} is a global situation information fusion vector of the agent i.

When global coalition policy estimation is performed, the used global situation information fusion vector of the agent i can be determined according to the following formula:

$${e}_{i}^{Q} = {f}^{concatenate} ( {e}_{i} , {e}_{i}^{g l o b a l} ) ,$$

where
eᵢ^{Q} is the global situation information fusion vector of the agent i, i is a reference number of the agent, ƒ^{concatenate}(⋅,⋅) is a vector concatenation function, eᵢ is a feature encoding vector of the agent i, and eᵢ^{global} is a non-proximal situation information fusion vector of the agent i.

The feature encoding vector eᵢ of the agent i is calculated according to the following formula:

$${e}_{i} = {f}^{e n c o d i n g} ( {o}_{i} ; {W}_{i , E} ) ,$$

where
ƒ^{encoding}(⋅;W_{i,E}) is a feature encoding model of the agent i, W_{i,E} is a model parameter of the feature encoding model of the agent i, and oᵢ is locally-observed information of the agent i.

The non-proximal situation information fusion vector eᵢ^{global} of the agent i is calculated according to the following formula:

$${e}_{i}^{global} = {β}_{jl} {e}_{jl} ,$$

where
both l and j are reference numbers of agents, [symbol] is a group reference number of the agent j, [symbol] is an agent set with the agent group reference number as [symbol] is a closest agent set of the agent i, the closest agent set includes a closest cooperative agent of the agent and a closest competitive agent of the agent; based on each agent in the closest agent set [symbol] of the agent i, all agents in an agent group to which the agent j belongs are used as global situation nodes, to form a non-proximal agent set [symbol] under a perspective of the agent i. In the formula, l∈ [symbol] , the non-proximal situation set includes another agent other than the agent, the closest cooperative agent of the agent, and the closest competitive agent of the agent. As shown in the situation relationship diagram in FIG. 3, a non-proximal situation set of the agent i includes another agent other than the red-party 3 and the blue-party 1, βⱼₗ is a fusion weight of a concatenation vector of the agent l and the agent j, and eⱼₗ is the concatenation vector of the agent j and the agent l.

The fusion weight βⱼₗ of the concatenation vector of the agent l and the agent j is calculated according to the following formula:

$${β}_{j l} = {f}^{softmax ( {e}_{j l} )} = \frac{exp ( {e}_{j l} )}{exp ( {e}_{j b} )} ,$$

where
ƒ^{softmax}(⋅) is a fusion weight calculation function, exp(⋅) is an exponential function with a natural constant e as a base, b is a reference number of an agent, and e_{jb} is a concatenation vector of the agent j and agent b.

The concatenation vector eⱼₗ of the agent j and the agent l is calculated according to the following formula:

$${e}_{j l} = {f}^{concatenate} ( {e}_{j} , {e}_{l} ) ,$$

where
eⱼ is a feature encoding vector of the agent j, and eₗ is a feature encoding vector of the agent l.

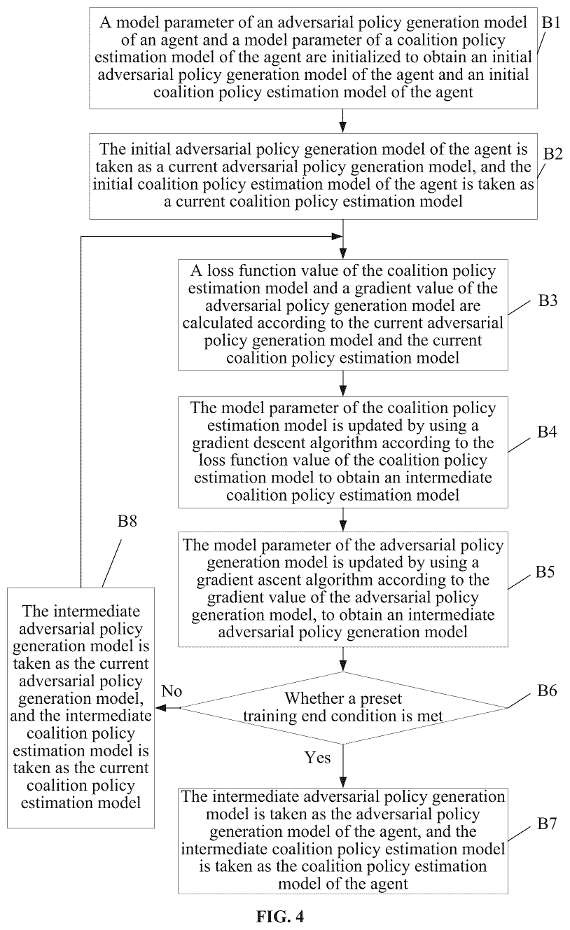

Specifically, in this embodiment, through an actor-critic model adopting centralized training and decentralized decision making, the adversarial policy generation model and the coalition policy value estimation model are iteratively trained. As shown in the flowchart in FIG. 4, a training process of the adversarial policy generation model of the agent includes the following steps.

Step B1, a model parameter of the adversarial policy generation model of the agent and a model parameter of the coalition policy estimation model of the agent are initialized to obtain an initial adversarial policy generation model of the agent and an initial coalition policy estimation model of the agent.

Step B2, the initial adversarial policy generation model of the agent is taken as a current adversarial policy generation model, and the initial coalition policy estimation model of the agent is taken as a current coalition policy estimation model.

Step B3, a loss function value of the coalition policy estimation model and a gradient value of the adversarial policy generation model are calculated according to the current adversarial policy generation model and the current coalition policy estimation model. A loss L( [symbol] ) of a coalition policy estimation model of the agent i is calculated:

$${\sum }_{( {e}_{i}^{π} , {e}_{i}^{Q} , a , {r}_{i} , {e}_{i}^{{π}^{′}} , {e}_{i}^{{Q}^{′}}} {( {f}^{Q} ( {e}_{i}^{Q} , a ; {W}_{i , Q} ) - {r}_{i} - γ {f}^{Q} ( {e}_{i}^{{Q}^{′}} , {a}^{′} ; {W}_{i , {Q}^{′}} ) )}^{2} .$$

A gradient ∇_{W}_{_{i,π}}J(W_{i,π}) of an agent decision-making network is calculated:

$${\sum }_{( {e}_{i}^{π} , {e}_{i}^{Q} , a , {r}_{i} , {e}_{i}^{{π}^{′}} , {e}_{i}^{{Q}^{′}}} {∇}_{{W}_{i , π}} {f}^{π} ( {e}_{i}^{π} ; {W}_{i , π} ) {∇}_{{a}_{i}} {f}^{Q} ( {e}_{i}^{Q} , a ; {W}_{i , Q} ) ,$$

where
[symbol] represents an experience pool with a capacity of 1024, aᵢ′=ƒ^{π}(eᵢ^{π′};W_{i,π′}), aᵢ=ƒ^{π}(eᵢ^{π};W_{i,π}), ∇_{W}_{_{i,π}} is used to calculate a gradient of a model parameter Wᵢ of the adversarial policy generation model, ∇ₐ_{ᵢ} is a calculated gradient of a model parameter [symbol] of the coalition policy estimation model, γ=0.99 is a hyperparameter, [symbol] and W_{i,π}′ are target model parameters of a corresponding model, and another parameter with ′ is a parameter at a next moment.

Step B4, the model parameter of the coalition policy estimation model is updated by using a gradient descent algorithm according to the loss function value of the coalition policy estimation model to obtain an intermediate coalition policy estimation model.

Step B5, the model parameter of the adversarial policy generation model is updated by using a gradient ascent algorithm according to the gradient value of the adversarial policy generation model, to obtain an intermediate adversarial policy generation model.

Step B6, it is determined whether a preset training end condition is met, to obtain a training end determining result.

If the training end determining result is yes, step B7 is performed; or if the training end determining result is no, step B8 is performed.

Step B7, the intermediate adversarial policy generation model is taken as the adversarial policy generation model of the agent, and the intermediate coalition policy estimation model is taken as the coalition policy estimation model of the agent.

Step B8, the intermediate adversarial policy generation model is taken as the current adversarial policy generation model, the intermediate coalition policy estimation model is taken as the current coalition policy estimation model, and step B3 is performed until the preset training end condition is met.

The following describes advantages of a method for generating a multi-agent adversarial policy based on a heterogeneous relationship according to an embodiment of the present disclosure by using a comparative example. An experimental environment of a 4vs4 red-blue robot football game confrontation task scenario is an open-source Unity3D virtual simulation reference experimental environment. There are eight robots and one simulated court in the environment. 4vs4 confrontation is performed among the eight robots, and the red-blue parties aim to kick the football into opponents' goals through intra-group collaboration.

A method for generating a multi-agent adversarial policy based on a heterogeneous relationship is the method in the present disclosure. A heterogeneous relationship among agents and a spatial topology structure are combined and used to model a game situation relationship for simulating and understanding a complex relationship among the agents more accurately. Through learning from local and global situation relationship characteristics, a local decision-making phase and a global training phase are balanced in a game adversarial policy learning process, to implement efficient utilization of situation information and effective generation of a game policy. DDPG represents a deep deterministic policy gradient model, and the game policy is only generated by a robot agent by using locally-observed information of the robot agent. MADDPG represents a multi-agent deep deterministic policy gradient, and the game policy is learned by the robot agent by using global policy information of all agents. HAMA represents a multi-agent layered attention model, and a game relationship in local space is only modelled by the agent for a policy training process.

Table 1 shows comparative results between the method in the present disclosure and three reference methods in the 4vs4 red-blue robot football game confrontation task scenario, where an evaluation index is a goal win rate of the blue party. For example, 31.3% on the third row and the third column in Table 1 represents a goal win rate of the blue party when the blue party is controlled by a DDPG algorithm and the red party is controlled by an ADDPG algorithm. Four methods are separately used to perform game confrontation on the red-blue robots for a plurality of times, and an average goal win rate of the blue party is obtained through statistics. A higher goal win rate of the blue party indicates more effectiveness of a game adversarial policy of the blue party.

TABLE 1
Game confrontation comparative results
4vs4 red-blue robot football game confrontation task scenario

| | | | | Method in this |
|---|---|---|---|---|
| Algorithm model | DDPG | MADDPG | HAMA | embodiment |
| DDPG | 52.6% | 31.3% | 29.1% | 17.4% |
| MADDPG | 70.3% | 55.1% | 36.6% | 25.6% |
| HAMA | 75.1% | 69.6% | 45.8% | 30.9% |
| Method in this | 83.7% | 75.3% | 68.1% | 51.2% |
| embodiment | | | | |

It can be learned from the experimental results in Table 1 that in the 4vs4 red-blue robot football game confrontation task scenario, when confronting the red-party robot controlled by each reference method, the blue-party robot controlled by the method in this embodiment achieves a high win rate. Especially, when the blue-party controlled by the method in this embodiment has a highest win rate of 83.7% when confronting the red-party controlled by using DDPG.

Embodiments of the present disclosure provide a method for generating a multi-agent adversarial policy based on a heterogeneous relationship. The method includes the following steps: A situation relationship diagram of each agent is constructed based on a heterogeneous relationship between agents and a spatial topology structure of each agent; then, a local situation information fusion vector of the agent is determined based on the situation relationship diagram of the agent; and finally, a proper adversarial policy is made based on the local situation information fusion vector of the agent by utilizing a pre-trained adversarial policy generation model of the agent. In the method provided in this embodiment, on the basis of the spatial topology structure, the heterogeneous relationship between agents is taken into consideration to generate the situation relationship diagram, so that a decision-making and generation model can have a better understanding of the situation relationship between agents, a gaming situation dynamic change condition between agents can be adapted, a gaming situation is expressed more accurately, an understanding and adapting capability of the generation model to a gaming situation is improved, and the agents are guided to generate an effective adversarial policy for the adversarial policy generation model. This helps the agents achieve gaming adversarial balance.

### Embodiment 2

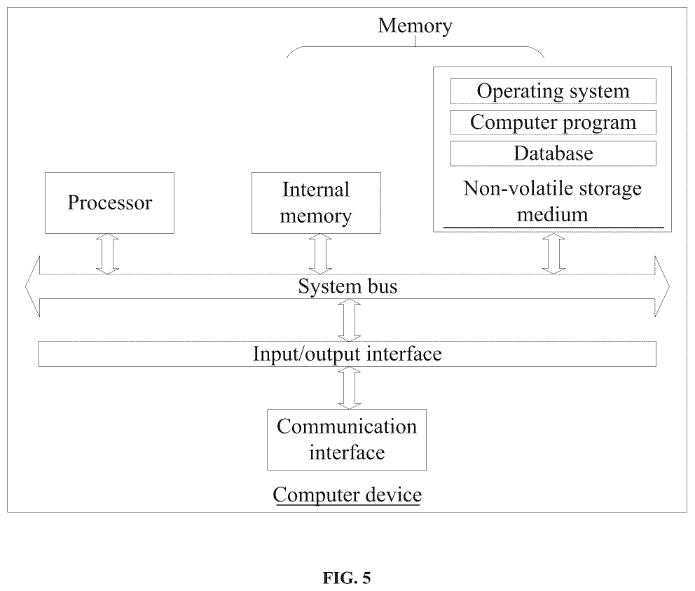

A computer device is provided in this embodiment. The computer device may be a database and can have an internal structure shown in FIG. 5. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a nonvolatile storage medium and an internal memory. The non-volatile storage medium stores an operating system, a computer program, and a database. The internal memory provides an environment for operation of the operating system and the computer program in the nonvolatile storage medium. The database of the computer device is configured to store pending transactions. The I/O interface of the computer device is configured to exchange information between the processor and an external device. The communication interface of the computer device is configured to communicate with an external terminal through a network. The computer program is executed by the process to implement the method for generating a multi-agent adversarial policy based on a heterogeneous relationship in Embodiment 1.

It is to be noted that information of an object (including but not limited to device information of the object, personal information of the object and the like) and data (including but not limited to data for analysis, data for storage, data for exhibition and the like) in the present disclosure are information and data authorized by the object or fully authorized by each party, and relevant data shall be acquired, used and processed according to laws, regulations and standards of related countries and regions.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to the memory, the database, or other media used in the embodiments of the present disclosure may include at least one of a nonvolatile memory and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor, a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A method for generating a multi-agent adversarial policy based on a heterogeneous relationship, comprising:
constructing for any agent, a situation relationship diagram of the agent based on a heterogeneous relationship between the agent and another agent and a spatial topology structure of each agent, wherein the heterogeneous relationship comprises a cooperative relationship and a competitive relationship; the situation relationship diagram comprises a situation relationship adjacency matrix and a situation relationship feature matrix; the situation relationship adjacency matrix represents the heterogeneous relationship between the agent and another agent; and the situation relationship feature matrix represents locally-observed information of each agent;
determining, based on the situation relationship diagram of the agent, a local situation information fusion vector of the agent, wherein the local situation information fusion vector is obtained according to locally-observed information of a closest cooperative agent of the agent and locally-observed information of a closest competitive agent of the agent; the closest cooperative agent is an agent whose heterogeneous relationship with the agent is the cooperative relationship and spatial distance to the agent is the shortest; and the closest competitive agent is an agent whose heterogeneous relationship with the agent is the competitive relationship and spatial distance to the agent is the shortest; and
inputting the local situation information fusion vector of the agent into an adversarial policy generation model of the agent to obtain an adversarial policy of the agent, wherein the adversarial policy generation model is a model obtained after centralized training is performed on an initial adversarial policy generation model for all agents and an initial coalition policy estimation model for all agents; the coalition policy estimation model is configured to score a coalesced adversarial policy vector according to a global situation information fusion vector of the agent; and the coalesced adversarial policy vector is a vector obtained by coalescing adversarial policies made by the adversarial policy generation model for all agents.

2. The method for generating a multi-agent adversarial policy based on a heterogeneous relationship according to claim 1, wherein an expression formula of the situation relationship diagram of the agent is as follows:
$${G}_{i} = < {A}_{i} , {X}_{i} > ,$$
wherein
i represents a reference number of an agent, Gᵢ represents a situation relationship diagram of agent i, Aᵢ represents a situation relationship adjacency matrix under a perspective of the agent i and indicates a heterogeneous relationship between the agent and another agent, Xᵢ represents a situation relationship feature matrix under the perspective of the agent i and indicates locally-observed information of each agent.

3. The method for generating a multi-agent adversarial policy based on a heterogeneous relationship according to claim 1, wherein the local situation information fusion vector of the agent is determined according to the following formula:
$${e}_{i}^{π} = {α}_{i j} {e}_{i j} ,$$
wherein
eᵢ^{π} is a local situation information fusion vector of agent i, j is a reference number of an agent, [symbol] is a closest agent set of the agent i, the closest agent set comprises a closest cooperative agent of the agent and a closest competitive agent of the agent, eᵢⱼ is a concatenation vector of the agent i and agent j, and αᵢⱼ is a fusion weight of the concatenation vector of the agent i and the agent j;
the concatenation vector eᵢⱼ of the agent i and the agent j is calculated according to the following formula:
$${e}_{i j} = {f}^{concatenate} ( {e}_{i} , {e}_{j} ) ,$$
wherein
ƒ^{concatenate}(⋅) is a vector concatenation function, eᵢ is a feature encoding vector of the agent i, and eⱼ is a feature encoding vector of the agent j;
the feature encoding vector eᵢ of the agent i is calculated according to the following formula:
$${e}_{i} = {f}^{e n c o d i n g} ( {o}_{i} ; {W}_{i , E} ) ,$$
wherein
ƒ^{encoding}(⋅; W_{i,E}) is a feature encoding model of the agent i, W_{i,E} is a model parameter of the feature encoding model of the agent i, and oᵢ is locally-observed information of the agent i;
the feature encoding vector eⱼ of the agent j is calculated according to the following formula:
$${e}_{j} = {f}^{e n c o d i n g} ( {o}_{j} ; {W}_{i , E} ) ,$$
wherein
oⱼ is locally-observed information of the agent j;
the fusion weight αᵢⱼ of the concatenation vector of the agent i and the agent j is calculated according to the following formula:
$${α}_{i j} = {f}^{softmax} ( {e}_{i j} ) = \frac{exp ( {e}_{i j} )}{exp ( {e}_{i l} )} ,$$
wherein
ƒ(⋅)^{softmax}(⋅) is a fusion weight calculation function, exp(⋅) is an exponential function with a natural constant e as a base, l is a reference number of an agent, and eᵢₗ is a concatenation vector of the agent i and the agent l.

4. The method for generating a multi-agent adversarial policy based on a heterogeneous relationship according to claim 1, wherein an expression formula of the adversarial policy generation model of the agent is as follows:
$${a}_{i} = {f}^{π} ( {e}_{i}^{π} ; {W}_{i , π} ) ,$$
wherein
aᵢ is an adversarial policy of agent i, ƒ^{π}(⋅;W_{i,π}) is an adversarial policy generation model of the agent i, eᵢ^{π} is a local situation information fusion vector of the agent i, and W_{i,π} is a model parameter of the adversarial policy generation model of the agent i.

5. The method for generating a multi-agent adversarial policy based on a heterogeneous relationship according to claim 1, wherein an expression formula of the coalition policy estimation model of the agent is as follows:
$${Q}_{i} ( {e}_{i}^{Q} , a ) = {f}^{Q} ( {e}_{i}^{Q} , a ; {W}_{i , Q} ) ,$$
wherein
Qᵢ(eᵢ^{Q},a) is a score given by a coalition policy estimation model of agent i for a according to eᵢ^{Q}, [symbol] is the coalition policy estimation model of the agent i, [symbol] is a model parameter of the coalition policy estimation model of the agent i, a is the coalesced adversarial policy vector obtained by coalescing adversarial policies made by the adversarial policy generation model for all agents, and eᵢ^{Q} is a global situation information fusion vector of the agent i.

6. The method for generating a multi-agent adversarial policy based on a heterogeneous relationship according to claim 5, wherein the global situation information fusion vector of the agent is determined according to the following formula:
$${e}_{i}^{Q} = {f}^{concatenate} ( {e}_{i} , {e}_{i}^{g l o b a l} ) ,$$
wherein
eᵢ^{Q} is the global situation information fusion vector of the agent i, i is a reference number of an agent, ƒ^{concatenate}(⋅,⋅) is a vector concatenation function, eᵢ is a feature encoding vector of the agent i, and eᵢ^{global} is a non-proximal situation information fusion vector of the agent i;
the feature encoding vector eᵢ of the agent i is calculated according to the following formula:
$${e}_{i} = {f}^{e n c o d i n g} ( {o}_{i} ; {W}_{i , E} ) ,$$
wherein
ƒ^{encoding}(⋅;W_{i,E}) is a feature encoding model of the agent i, W_{i,E} is a model parameter of the feature encoding model of the agent i, and oᵢ is locally-observed information of the agent i;
the non-proximal situation information fusion vector eᵢ^{global} of the agent i is calculated according to the following formula:
$${e}_{i}^{g l o b a l} = {β}_{j l} {e}_{j l} ,$$
wherein
both l and j are reference numbers of agents, [symbol] is a group reference number of agent j, [symbol] is an agent set with the agent group reference number as [symbol] is a closest agent set of the agent i, the closest agent set comprises a closest cooperative agent of the agent and a closest competitive agent of the agent, l∈ [symbol] , [symbol] is a non-proximal situation agent set of the agent i, the non-proximal situation set comprises another agent other than the agent, the closest cooperative agent of the agent, and the closest competitive agent of the agent, βⱼₗ is a fusion weight of a concatenation vector of the agent l and the agent j, and eⱼₗ is the concatenation vector of the agent j and the agent l;
the fusion weight βⱼₗ of the concatenation vector of the agent l and the agent j is calculated according to the following formula:
$${β}_{jl} = {f}^{softmax ( {e}_{jl} )} = \frac{exp ( {e}_{jl} )}{exp ( {e}_{jb} )} ,$$
wherein
ƒ^{softmax}(⋅) is a fusion weight calculation function, exp(⋅) is an exponential function with a natural constant e as a base, b is a reference number of an agent, and e_{jb} is a concatenation vector of the agent j and agent b; and
the concatenation vector eⱼₗ of the agent j and the agent l is calculated according to the following formula:
$${e}_{jl} = {f}^{concatenate} ( {e}_{j} , {e}_{l} ) ,$$
wherein
eⱼ is a feature encoding vector of the agent j, and eₗ is a feature encoding vector of the agent l.

7. The method for generating a multi-agent adversarial policy based on a heterogeneous relationship according to claim 1, wherein a training process of the adversarial policy generation model of the agent comprises:
initializing a model parameter of the adversarial policy generation model of the agent and a model parameter of the coalition policy estimation model of the agent to obtain an initial adversarial policy generation model of the agent and an initial coalition policy estimation model of the agent;
taking the initial adversarial policy generation model of the agent as a current adversarial policy generation model, and taking the initial coalition policy estimation model of the agent as a current coalition policy estimation model;
calculating, according to the current adversarial policy generation model and the current coalition policy estimation model, a loss function value of the coalition policy estimation model and a gradient value of the adversarial policy generation model;
updating, according to the loss function value of the coalition policy estimation model, the model parameter of the coalition policy estimation model by using a gradient descent algorithm to obtain an intermediate coalition policy estimation model;
updating, according to the gradient value of the adversarial policy generation model, the model parameter of the adversarial policy generation model by using a gradient ascent algorithm to obtain an intermediate adversarial policy generation model;
determining whether a preset training end condition is met, to obtain a training end determining result; and
if the training end determining result is yes, taking the intermediate adversarial policy generation model as the adversarial policy generation model of the agent, and taking the intermediate coalition policy estimation model as the coalition policy estimation model of the agent; or
if the training end determining result is no, taking the intermediate adversarial policy generation model as the current adversarial policy generation model, taking the intermediate coalition policy estimation model as the current coalition policy estimation model, and skipping to the following step: calculating, according to the current adversarial policy generation model and the current coalition policy estimation model, the loss function value of the coalition policy estimation model and the gradient value of the adversarial policy generation model until the preset training end condition is met.

8. The method for generating a multi-agent adversarial policy based on a heterogeneous relationship according to claim 1, wherein the constructing for any agent, based on a heterogeneous relationship between the agent and another agent and a spatial topology structure of each agent, a situation relationship diagram of the agent specifically comprises:
initializing the situation relationship diagram of the agent to obtain an initial situation relationship diagram of the agent; and
updating, according to the heterogeneous relationship between the agent and another agent and locally-observed information of all agents, the initial situation relationship diagram of the agent, to obtain the situation relationship diagram of the agent.

9. The method for generating a multi-agent adversarial policy based on a heterogeneous relationship according to claim 8, wherein the situation relationship diagram comprises the situation relationship adjacency matrix and the situation relationship feature matrix, and the initializing the situation relationship diagram of the agent specifically comprises:
setting data in the situation relationship adjacency matrix to zero, and setting data in the situation relationship feature matrix to zero, to obtain the initial situation relationship diagram of the agent.

10. A computer device, comprising a memory, a processor, and a computer program stored in the memory and executable on the processor, wherein the processor executes the computer program to implement steps of the method for generating a multi-agent adversarial policy based on a heterogeneous relationship according to claim 1.

11. The computer device according to claim 10, wherein an expression formula of the situation relationship diagram of the agent is as follows:
$${G}_{i} = < {A}_{i} , {X}_{i} > ,$$
i represents a reference number of an agent, Gᵢ represents a situation relationship diagram of agent i, Aᵢ represents a situation relationship adjacency matrix under a perspective of the agent i and indicates a heterogeneous relationship between the agent and another agent, Xᵢ represents a situation relationship feature matrix under the perspective of the agent i and indicates locally-observed information of each agent.

12. The computer device according to claim 10, wherein the local situation information fusion vector of the agent is determined according to the following formula:
$${e}_{i}^{π} = {α}_{ij} {e}_{ij} ,$$
wherein
eᵢ^{π} is a local situation information fusion vector of agent i, j is a reference number of an agent, [symbol] is a closest agent set of the agent i, the closest agent set comprises a closest cooperative agent of the agent and a closest competitive agent of the agent, eᵢⱼ is a concatenation vector of the agent i and agent j, and αᵢⱼ is a fusion weight of the concatenation vector of the agent i and the agent j;
the concatenation vector eᵢⱼ of the agent i and the agent j is calculated according to the following formula:
$${e}_{ij} = {f}^{concatenate} ( {e}_{i} , {e}_{j} ) ,$$
wherein
ƒ^{concatenate}(,⋅) is a vector concatenation function, eᵢ is a feature encoding vector of the agent i, and eⱼ is a feature encoding vector of the agent j;
the feature encoding vector eᵢ of the agent i is calculated according to the following formula:
$${e}_{i} = {f}^{encoding} ( {o}_{i} ; {W}_{i , E} ) ,$$
wherein
ƒ^{encoding}(⋅;W_{i,E}) is a feature encoding model of the agent i, W_{i,E} is a model parameter of the feature encoding model of the agent i, and oᵢ is locally-observed information of the agent i;
the feature encoding vector eⱼ of the agent j is calculated according to the following formula:
$${e}_{j} = {f}^{encoding} ( {o}_{j} ; {W}_{i , E} ) ,$$
oⱼ is locally-observed information of the agent j;
the fusion weight αᵢⱼ of the concatenation vector of the agent i and the agent j is calculated according to the following formula:
$${α}_{ij} = {f}^{softmax} ( {e}_{ij} ) = \frac{exp ( {e}_{ij} )}{} ,$$
wherein
ƒ(⋅)^{softmax}(⋅) is a fusion weight calculation function, exp(⋅) is an exponential function with a natural constant e as a base, l is a reference number of an agent, and ea is a concatenation vector of the agent i and the agent l.

13. The computer device according to claim 10, wherein an expression formula of the adversarial policy generation model of the agent is as follows:
$${a}_{i} = {f}^{π} ( {e}_{i}^{π} ; {W}_{i , π} ) ,$$
wherein
aᵢ is an adversarial policy of agent i, ƒ^{π}(⋅;W_{i,π}) is an adversarial policy generation model of the agent i, eᵢ^{π} is a local situation information fusion vector of the agent i, and W_{i,π} is a model parameter of the adversarial policy generation model of the agent i.

14. The computer device according to claim 10, wherein an expression formula of the coalition policy estimation model of the agent is as follows:
$${Q}_{i} ( {e}_{i}^{Q} , a ) = {f}^{Q} ( {e}_{i}^{Q} , a ; {W}_{i , Q} ) ,$$
wherein
Qᵢ(eᵢ^{Q},a) is a score given by a coalition policy estimation model of agent i for a according to eᵢ^{Q}, [symbol] is the coalition policy estimation model of the agent i, [symbol] is a model parameter of the coalition policy estimation model of the agent i, a is the coalesced adversarial policy vector obtained by coalescing adversarial policies made by the adversarial policy generation model for all agents, and eᵢ^{Q} is a global situation information fusion vector of the agent i.

15. The computer device according to claim 14, wherein the global situation information fusion vector of the agent is determined according to the following formula:
$${e}_{i}^{Q} = {f}^{concatenate} ( {e}_{i} , {e}_{i}^{global} ) ,$$
wherein
eᵢ^{Q} is the global situation information fusion vector of the agent i, i is a reference number of an agent, ƒ^{concatenate}(⋅,⋅) is a vector concatenation function, eᵢ is a feature encoding vector of the agent i, and eᵢ^{global} is a non-proximal situation information fusion vector of the agent i;
the feature encoding vector eᵢ of the agent i is calculated according to the following formula:
$${e}_{i} = {f}^{encoding} ( {o}_{i} ; {W}_{i , E} ) ,$$
wherein
ƒ^{encoding}(⋅;W_{i,E}) is a feature encoding model of the agent i, W_{i,E} is a model parameter of the feature encoding model of the agent i, and oᵢ is locally-observed information of the agent i;
the non-proximal situation information fusion vector eᵢ^{global} of the agent i is calculated according to the following formula:
$${e}_{i}^{global} = {β}_{jl} {e}_{jl} ,$$
wherein
both l and j are reference numbers of agents, [symbol] is a group reference number of agent j, [symbol] is an agent set with the agent group reference number as [symbol] is a closest agent set of the agent i, the closest agent set comprises a closest cooperative agent of the agent and a closest competitive agent of the agent, l∈ [symbol] , [symbol] is a non-proximal situation agent set of the agent i, the non-proximal situation set comprises another agent other than the agent, the closest cooperative agent of the agent, and the closest competitive agent of the agent, βⱼₗ is a fusion weight of a concatenation vector of the agent l and the agent j, and eⱼₗ is the concatenation vector of the agent j and the agent l;
the fusion weight βⱼₗ of the concatenation vector of the agent l and the agent j is calculated according to the following formula:
$${β}_{jl} = {f}^{softmax ( {e}_{jl} )} = \frac{exp ( {e}_{jl} )}{exp ( {e}_{jb} )} ,$$
wherein
ƒ^{softmax}(⋅) is a fusion weight calculation function, exp(⋅) is an exponential function with a natural constant e as a base, b is a reference number of an agent, and e_{jb} is a concatenation vector of the agent j and agent b; and
the concatenation vector eⱼₗ of the agent j and the agent l is calculated according to the following formula:
$${e}_{jl} = {f}^{concatenate} ( {e}_{j} , {e}_{l} ) ,$$
wherein
eⱼ is a feature encoding vector of the agent j, and eₗ is a feature encoding vector of the agent l.

16. The computer device according to claim 10, wherein a training process of the adversarial policy generation model of the agent comprises:
initializing a model parameter of the adversarial policy generation model of the agent and a model parameter of the coalition policy estimation model of the agent to obtain an initial adversarial policy generation model of the agent and an initial coalition policy estimation model of the agent;
taking the initial adversarial policy generation model of the agent as a current adversarial policy generation model, and taking the initial coalition policy estimation model of the agent as a current coalition policy estimation model;
calculating, according to the current adversarial policy generation model and the current coalition policy estimation model, a loss function value of the coalition policy estimation model and a gradient value of the adversarial policy generation model;
updating, according to the loss function value of the coalition policy estimation model, the model parameter of the coalition policy estimation model by using a gradient descent algorithm to obtain an intermediate coalition policy estimation model;
updating, according to the gradient value of the adversarial policy generation model, the model parameter of the adversarial policy generation model by using a gradient ascent algorithm to obtain an intermediate adversarial policy generation model;
determining whether a preset training end condition is met, to obtain a training end determining result; and
if the training end determining result is yes, taking the intermediate adversarial policy generation model as the adversarial policy generation model of the agent, and taking the intermediate coalition policy estimation model as the coalition policy estimation model of the agent; or
if the training end determining result is no, taking the intermediate adversarial policy generation model as the current adversarial policy generation model, taking the intermediate coalition policy estimation model as the current coalition policy estimation model, and skipping to the following step: calculating, according to the current adversarial policy generation model and the current coalition policy estimation model, the loss function value of the coalition policy estimation model and the gradient value of the adversarial policy generation model until the preset training end condition is met.

17. The computer device according to claim 10, wherein the constructing for any agent, based on a heterogeneous relationship between the agent and another agent and a spatial topology structure of each agent, a situation relationship diagram of the agent specifically comprises:
initializing the situation relationship diagram of the agent to obtain an initial situation relationship diagram of the agent; and
updating, according to the heterogeneous relationship between the agent and another agent and locally-observed information of all agents, the initial situation relationship diagram of the agent, to obtain the situation relationship diagram of the agent.

18. The computer device according to claim 17, wherein the situation relationship diagram comprises the situation relationship adjacency matrix and the situation relationship feature matrix, and the initializing the situation relationship diagram of the agent specifically comprises:
setting data in the situation relationship adjacency matrix to zero, and setting data in the situation relationship feature matrix to zero, to obtain the initial situation relationship diagram of the agent.
